(19) United States
(12) Patent Application Publication
(10) Pub. No.: US 2012/0133633 A1
(43) Pub. Date: May 31, 2012

(54) DISPLAY DEVICE, ELECTRONIC DEVICE, AND METHOD OF DRIVING DISPLAY DEVICE

(75) Inventors: Naobumi Toyomura, Kanagawa (JP); Katsuhide Uchino, Kanagawa (JP)

(73) Assignee: Sony Corporation, Tokyo (JP)

(21) Appl. No.: 13/350,000

(22) Filed: Jan. 13, 2012

Related U.S. Application Data
(62) Division of application No. 12/588,605, filed on Oct. 21, 2009, now Pat. No. 8,098,241.

(30) Foreign Application Priority Data
Nov. 12, 2008 (JP) 2008-289674

(51) Int. Cl. G09G 5/00

(52) U.S. Cl. 345/211

(57) ABSTRACT

A display device is provided having improved reliability compared with the related art. The display device includes, for each pixel: a photo-emission element and a first MOS transistor connected in series between a first power source line and a second power source line; a capacitor connected to be inserted between a gate and a source of the first MOS transistor; and a second MOS transistor connected to be inserted between a signal line to be applied with a image signal voltage and the gate of the first MOS transistor, the second MOS transistor being controlled by a scan signal to change between ON-state and OFF-state, wherein ON-period of the first transistor is established within a period in which the photo-emission element is maintained to an extinction state and the signal line is applied with a voltage having a fixed level independent from the image signal voltage.

This is a divisional application of U.S. patent application Ser. No. 12/588,605, filed Oct. 21, 2009, which in turn claims priority from Japanese Priority Patent Application JP 2008-289674 filed in the Japan Patent Office on Nov. 12, 2008, the entire content of which is hereby incorporated by reference.

### BACKGROUND OF THE INVENTION

1. Field of the Invention

The present invention relates to a display device including a display section having a photo emission element and a pixel circuit for each pixel, and a method of driving the display device, and to an electronic device having such a display device.

2. Description of the Related Art

Recently, in a field of a display device performing image display, a display device is developed and progressively commercialized, which uses a current-drive optical element, for example, an organic EL (Electro Luminescence) element, as a photo emission element of a pixel, emission luminance of the optical element varying depending on a current value.

The organic EL element is a self-luminous element unlike a liquid crystal element. Therefore, a display device using the organic EL element (organic EL display device) does not need a light source (backlight), and therefore the display device is high in visibility of an image, low in power consumption, and high in response speed of an element compared with a liquid crystal display device needing a light source.

In the organic EL display device, a drive method includes a simple (passive) matrix method and an active matrix method as in the liquid crystal display device. The former has a simple structure, but has a difficulty that a large, high-resolution display device is hardly achieved. Therefore, the active matrix method is currently actively developed. In this method, a current flowing into a photo emission element disposed for each pixel is controlled by an active element (typically, TFT (Thin Film Transistor) provided in a drive circuit provided for each photo emission element.

Generally, a current-voltage (I-V) characteristic of the organic EL element is deteriorated with time (aged deterioration). In a pixel circuit for current drive of the organic EL element, when the I-V characteristic of the organic EL element is changed with time, a voltage-dividing ratio of the organic EL element to a drive transistor connected in series to the EL element is changed, and therefore a voltage V_{gs} between a gate and source of the drive transistor is also changed. As a result, since a value of current flowing into the drive transistor is also changed, a value of current flowing into the organic EL element is also changed, and consequently emission luminance is changed in accordance with the current value.

In some cases, a threshold voltage Vₜₕ or mobility μ of the drive transistor is temporally changed, or the threshold voltage Vₜₕ or mobility μ varies for each pixel circuit due to variation in manufacturing process. When the threshold voltage Vₜₕ or mobility μ of the drive transistor varies for each pixel circuit in this way, a value of current flowing into the drive transistor varies for each pixel circuit. Therefore, even if the same voltage is applied to a gate of the drive transistor, emission luminance of the organic EL element may vary, leading to loss in uniformity of a screen.

Thus, a proposal has been made in order to achieve that even if the I-V characteristic of the organic EL element is changed with time, or even if the threshold voltage Vₜₕ or mobility μ of the drive transistor is changed with time, emission luminance of the organic EL element is kept to a certain luminance without being affected by such change. Specifically, a display device is developed, which incorporates a function of compensating variation in I-V characteristic of the organic EL element, and a function of correcting variation in threshold voltage Vₜₕ or in mobility μ of the drive transistor (for example, described in Japanese Unexamined Patent Application Publication No. 2008-33193).

### SUMMARY OF THE INVENTION

In the Japanese Unexamined Patent Application, Publication No. 2008-33193, not only the drive transistor but also a sampling transistor is provided in a pixel circuit. The sampling transistor is OFF in a period except for a correction period of the threshold voltage Vₜₕ and a write period of a data signal. In such an OFF state, the transistor is applied with a minus bias voltage (reverse bias voltage) particularly during white display.

It is known that when a minus bias voltage is applied to a transistor, a threshold voltage Vₜₕ of the transistor is temporally minus-shifted (varies in a negative voltage direction). When a threshold voltage Vₜₕ of a sampling transistor is minus-shifted, since a turn-on/cutoff point of the transistor is shifted to a lower voltage side, write time is lengthened. This results in a difficulty that temporal reduction in emission current value is accelerated due to such lengthened write time.

In this way, in the related art, temporal reduction in emission current value is disadvantageously accelerated due to lengthened write time caused by variation in Vₜₕ of the sampling transistor, leading to reliability degradation, and there is a room for improvement.

In view of foregoing, it is desirable to provide a display device and an electronic device, of which the reliability may be improved compared with the related art, and a method of driving the display device.

According to an embodiment of the invention, there is provided a display device including: a display section having a photo-emission element and a pixel circuit for each pixel, the photo-emission element having an anode and a cathode, the pixel circuit having a first transistor, a second transistor and a holding capacitor; and a drive section driving the pixel circuit based on a image signal, the drive section having a first drive section, a second drive section, a third drive section, a control section, a first wiring, a second wiring, a third wiring, and a fourth wiring set to a reference voltage. A gate of the first transistor is connected to the first drive section via the first wiring, a drain or source of the first transistor is connected to the third drive section via the third wiring, one of the drain and source, unconnected to the third drive section, of the first transistor is connected to a gate of the second transistor and to one end of the holding capacitor, a drain or source of the second transistor is connected to the second drive section via the second wiring, one of the drain and source, unconnected to the second drive section, of the second transistor is connected to other end of the holding capacitor and to the anode of the photo-emission element, the cathode of the photo-emission element is connected to the fourth wiring. The first drive section selectively outputs, to the first wiring, a first voltage lower than an ON-voltage of the first transistor, or a second voltage equal to or higher than the ON-voltage of the first transistor. The second drive section selectively outputs, to the second wiring, a third voltage lower than sum of a threshold voltage of the photo-emission element and the reference voltage, or a fourth voltage equal to or higher than the sum of the threshold voltage of the photo-emission element and the reference voltage. The third drive section selectively outputs, to the third wiring, a fifth voltage having a fixed level independent from the image signal, or a sixth voltage having a level based on the image signal. The control section outputs a control signal to the first drive section, the control signal instructing the first drive section to establish ON-period of the first transistor within a period in which voltage of the second wiring is maintained to the third voltage to set the photo-emission element into an extinction state and voltage of the third wiring is maintained to the fifth voltage, the ON-period of the first transistor being defined as a period from a timing at which voltage of the first wiring rises from the first voltage to the second voltage to another timing at which the voltage of the first wiring falls from the second voltage to the first voltage.

An electronic device of an embodiment of the invention has the display device.

According to an embodiment of the invention, there is provided a method of driving a display device comprising steps of: providing a display section including a photo-emission element and a pixel circuit for each pixel, and providing a drive section driving the pixel circuit based on a image signal, the photo-emission element having an anode and a cathode, the pixel circuit having a first transistor, a second transistor and a holding capacitor; connecting a gate of the first transistor to the first wiring, connecting a drain or source of the first transistor to the third wiring, and connecting other one of the drain and source of the first transistor to a gate of the second transistor and to one end of the holding capacitor; connecting a gate of the second transistor to the other one of the drain and source of the first transistor and to the one end of the holding capacitor, connecting a drain or a source of the second transistor to the second wiring, and connecting other one of the drain and source of the second transistor to other end of the holding capacitor and to the anode of the photo-emission element; connecting the cathode of the photo-emission element to the fourth wiring set to a reference voltage; selectively supplying the first wiring with a first voltage lower than ON-voltage of the first transistor or a second voltage equal to or higher than the ON-voltage of the first transistor; selectively supplying the second wiring with a third voltage lower than sum of a threshold voltage of the photo-emission element and the reference voltage or a fourth voltage equal to or higher than the sum of the threshold voltage of the photo-emission element and the reference voltage; and selectively supplying the third wiring with a fifth voltage having a fixed level independent from the image signal, or a sixth voltage having a level based on the image signal. ON-period of the first transistor is established within a period in which voltage of the second wiring is maintained to the third voltage to set the photo-emission element into an extinction state and voltage of the third wiring is maintained to the fifth voltage, the ON-period of the first transistor being defined as a period from a timing at which voltage of the first wiring rises from the first voltage to the second voltage to another timing at which the voltage of the first wiring falls from the second voltage to the first voltage.

According to an embodiment of the invention, there is provided a display device, including for each pixel: a photo-emission element and a first MOS transistor connected in series between a first power source line and a second power source line; a capacitor connected to be inserted between a gate and a source of the first MOS transistor; and a second MOS transistor connected to be inserted between a signal line to be applied with a image signal voltage and the gate of the first MOS transistor, the second MOS transistor being controlled by a scan signal to change between ON-state and OFF-state. ON-period of the first transistor is established within a period in which the photo-emission element is maintained to an extinction state and the signal line is applied with a voltage having a fixed level independent from the image signal voltage.

In the display device, the electronic device, and the method of driving the display device of an embodiment of the invention, the control signal instructs the first drive section to establish ON-period of the first transistor within a period in which voltage of the second wiring is maintained to the third voltage to set the photo-emission element into an extinction state and voltage of the third wiring is maintained to the fifth voltage, the ON-period of the first transistor being defined as a period from a timing at which voltage of the first wiring rises from the first voltage to the second voltage to another timing at which the voltage of the first wiring falls from the second voltage to the first voltage. This accelerates plus shift (variation in a positive voltage direction) of Vₜₕ (threshold voltage) of the first transistor, enabling cancel of a variation level of minus shift (variation in a negative voltage direction) of Vₜₕ (threshold voltage) of the first transistor in the past. Therefore, variation in Vₜₕ of the first transistor is suppressed, which suppresses acceleration in temporal reduction in light emission current value due to lengthened write time caused by such variation in Vₜₕ.

According to the display device, the electronic device, and the method of driving the display device of an embodiment of the invention, the control signal instructs the first drive section to establish ON-period of the first transistor within a period in which voltage of the second wiring is maintained to the third voltage to set the photo-emission element into an extinction state and voltage of the third wiring is maintained to the fifth voltage, the ON-period of the first transistor being defined as a period from a timing at which voltage of the first wiring rises from the first voltage to the second voltage to another timing at which the voltage of the first wiring falls from the second voltage to the first voltage. Therefore variation in Vₜₕ of the first transistor is suppressed, and consequently acceleration in temporal reduction in light emission current value may be suppressed. Accordingly, reliability may be improved compared with the related art.

Other and further objects, features and advantages of the invention will appear more fully from the following description.

### BRIEF DESCRIPTION OF THE DRAWINGS

FIG. 1 is a block diagram showing an example of a display device according to an embodiment of the invention.

FIG. 2 is a configurational diagram showing an example of an internal configuration of a pixel in FIG. 1.

FIG. 3 is waveform diagrams for illustrating an example of operation of a display device according to a comparative example.

FIG. 4 is a circuit diagram showing an example of an operating point of a transistor during white display of the display device according to the comparative example.

FIG. 5 is a characteristic diagram for illustrating minus shift of a transistor characteristic of the display device according to the comparative example.

FIG. 6 is waveform diagrams for illustrating signal write time in the display device according to the comparative example.

FIG. 7 is a characteristic diagram for illustrating a relationship between signal write time and a panel current value in the display device according to the comparative example.

FIG. 8 is a characteristic diagram for illustrating a relationship between panel drive time and a panel current value in the display device according to the comparative example.

FIG. 9 is waveform diagrams for illustrating an example of operation of a display device according to the embodiment.

FIG. 10 is a circuit diagram showing an example of an operating point of a transistor during an extinction period of the display device shown in FIG. 1.

FIG. 11 is a characteristic diagram for illustrating plus shift of a transistor characteristic of the display device shown in FIG. 1.

FIG. 12 is a plan view showing a schematic configuration of a module including the display device of the embodiment.

FIG. 13 is a perspective view showing appearance of application example 1 of the display device of the embodiment.

FIG. 14A is a perspective view showing appearance of application example 2 as viewed from a front side, and FIG. 14B is a perspective view showing appearance thereof as viewed from a back side.

FIG. 15 is a perspective view showing appearance of application example 3.

FIG. 16 is a perspective view showing appearance of application example 4.

FIG. 17A is a front view of application example 5 in an opened state, FIG. 17B is a side view thereof, FIG. 17C is a front view of the application example 5 in a closed state, FIG. 17D is a left side view thereof, FIG. 17E is a right side view thereof, FIG. 17F is a top view thereof, and FIG. 17G is a bottom view thereof.

### DETAILED DESCRIPTION OF THE PREFERRED EMBODIMENT

Hereinafter, a preferred embodiment of the invention will be described in detail with reference to drawings.

Example of Entire Configuration of Display Device

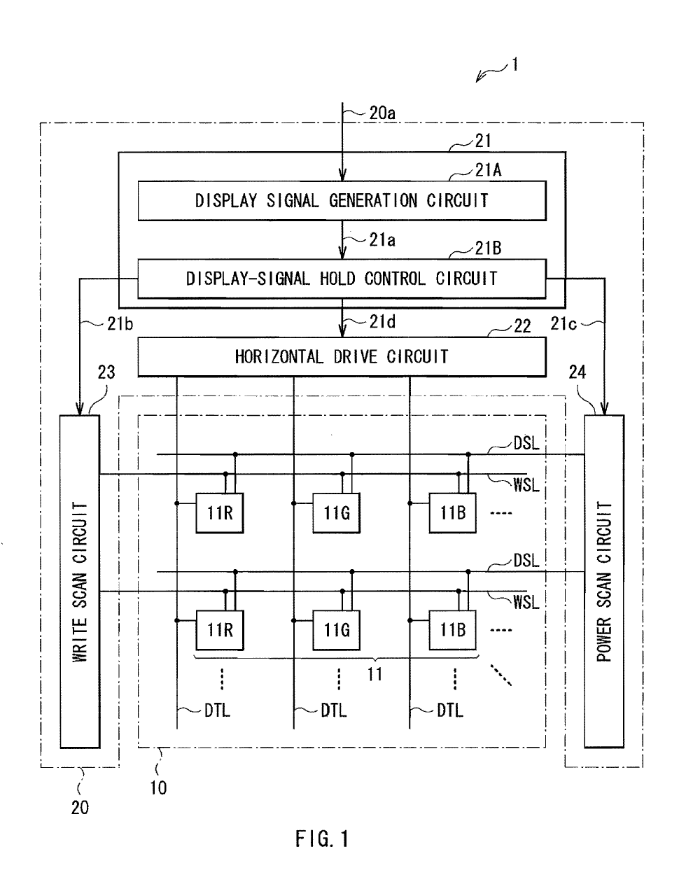

FIG. 1 shows an example of an entire configuration of a display device 1 according to an embodiment of the invention. The display device 1 has a display section 10 and a peripheral circuit section 20 (drive section) formed in the periphery of the display section 10 on a substrate (not shown) including, for example, glass, a silicon (Si) wafer, or resin.

The display section 10 includes a plurality of pixels 11 arranged in a matrix pattern over the whole surface of the display section 10, and displays an image based on an externally inputted video signal 20a by active matrix drive. Each pixel 11 includes a red pixel 11R, a green pixel 11G and a blue pixel 11B.

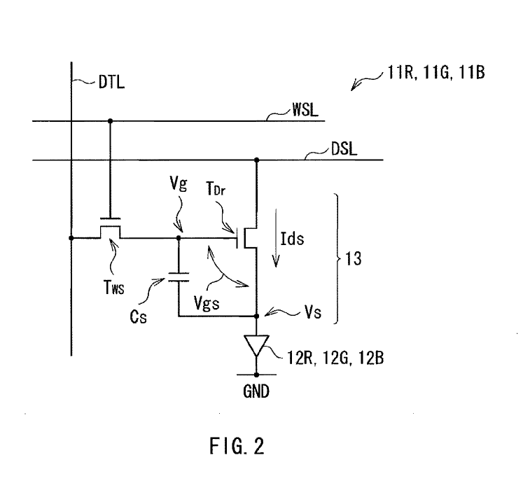

FIG. 2 shows an example of an internal configuration of a pixel 11R, 11G or 11B. An organic EL element 12R, 12G or 12B (photo-emission element) and a pixel circuit 13 are provided in the pixel 11R, 11G or 11B respectively.

For example, the organic EL element 12R, 12G or 12B (hereinafter, called organic EL element 12R or the like) has, while not shown, a configuration where an anode, an organic layer and a cathode are stacked in order from a substrate side. The organic layer has, for example, a stacked structure where a hole injection layer improving hole injection efficiency, a hole transport layer improving hole transport efficiency to a light emitting layer, the light emitting layer emitting light induced by recombination of an electron and a hole, and an electron transport layer improving electron transport efficiency to the light emitting layer are stacked in order from an anode side.

The pixel circuit 13 includes a sampling transistor T_{ws} (first transistor), a retention volume Cs, and a drive transistor T_{Dr} (second transistor), that is, has a 2Tr1C circuit configuration. The transistor T_{ws} or T_{Dr} is, for example, formed of an n-channel MOS thin film transistor (TFT).

The peripheral circuit section 20 has a timing control circuit 21 (control section), a horizontal drive circuit 22 (third drive section), a write scan circuit 23 (first drive section), and a power scan circuit 24 (second drive section). The timing control circuit 21 includes a display signal generation circuit 21A and a display-signal hold control circuit 21B. Moreover, the peripheral circuit section 20 has gate lines WSL (first wirings), drain lines DSL (second wirings), signal lines DTL (third wirings), and ground lines GND (fourth wirings). The ground lines GND are connected to ground, and thus set to ground voltage (reference voltage).

The display signal generation circuit 21A generates a display signal 21a for displaying an image on the display section 10, for example, for each picture (for each field display) based on the externally inputted video signal 20a.

The display-signal hold control circuit 21B stores the display signal 21a outputted from the display signal generation circuit 21A for each picture (for each field display) into a field memory including SRAM (Static Random Access Memory) or the like and holds the signal therein. In addition, the display-signal hold control circuit 21B controls the horizontal drive circuit 22 driving each pixel 11, the write scan circuit 23, and the power scan circuit 24 such that the circuits operate in an interlocked manner. Specifically, the display-signal hold control circuit 21B outputs a control signal 21b to the write scan circuit 23, outputs a control signal 21c to the power scan circuit 24, and outputs a control signal 21d to the horizontal drive circuit 22.

The horizontal drive circuit 22 may output two kinds of voltages (V_{ofs} (fifth voltage) and V_{sig} (sixth voltage)) corresponding to the control signal 21d outputted from the display-signal hold control circuit 21B. Specifically, the horizontal drive circuit 22 supplies the two kinds of voltages (V_{ofs} and V_{sig}) to a pixel 11 selected by the write scan circuit 23 via a signal line DTL connected to each pixel 11 of the display section 10.

V_{sig} has a voltage value corresponding to the video signal 20a. The lowest voltage of V_{sig} has a low voltage value compared with V_{ofs}, and the highest voltage of V_{sig} has a high voltage value compared with V_{ofs}.

The write scan circuit 23 may output two kinds of voltages (Vₒₙ (second voltage) and V_{off} (first voltage)) corresponding to the control signal 21b outputted from the display-signal hold control circuit 21B. Specifically, the write scan circuit 23 supplies the two kinds of voltages (Vₒₙ and V_{off}) to a pixel 11 as a drive object via a gate line WSL connected to each pixel 11 of the display section 10 so as to control the sampling transistor T_{ws}.

Vₒₙ has a value equal to or higher than a value of ON voltage of the transistor T_{ws}. Vₒₙ has a value of voltage outputted from the write scan circuit 23 in a Vₜₕ correction preparatory period, a Vₜₕ correction period, or a write/μ correction period, each period being described later. V_{off} has a value lower than a value of ON voltage of the transistor T_{ws}, and lower than the value of Vₒₙ. V_{off} has a value of voltage outputted from the write scan circuit 23 in the Vₜₕ correction preparatory period, a Vₜₕ correction suspension period, or a light emission period, each period being described later.

The power scan circuit 24 may output two kinds of voltages (Vᵢₙᵢ (third voltage) and V_{cc} (fourth voltage)) corresponding to the control signal 21c outputted from the display-signal hold control circuit 21B. Specifically, the power scan circuit 24 supplies the two kinds of voltages (Vᵢₙᵢ and V_{cc}) to a pixel 11 as a drive object via a drain line DSL connected to each pixel 11 of the display section 10 so as to control light emission of the organic EL element 12R or the like and extinction of the light.

Vᵢₙᵢ has a value of voltage lower than the total voltage (Vₑₗ+V_{ca}) of a threshold voltage Vₑₗ of the organic EL element 12R or the like and a cathode voltage V_{ca} thereof. Vcc has a value of voltage equal to or higher than the voltage (Vₑₗ+V_{ca}).

Next, a connection relationship between the components is described with reference to FIG. 2. Each gate line WSL led from the write scan circuit 23 is formed extendedly in a row direction, and connected to a gate of the transistor T_{ws}. Each drain line DSL led from the power scan circuit 24 is also formed extendedly in a row direction, and connected to a drain of the transistor T_{Dr}. Each signal line DTL led from the horizontal drive circuit 22 is formed extendedly in a column direction, and connected to a source of the transistor T_{ws}. A drain of the transistor T_{ws} is connected to a gate of the drive transistor T_{Dr} and to one end of the retention volume Cₛ, and a source of the transistor T_{Dr} and the other end of the retention volume Cₛ are connected to an anode of the organic EL element 12R or the like respectively. A cathode of the organic EL element 12R or the like is connected to the ground line GND.

Operation and Effects of Display Device

Next, operation and effects of the display device 1 of the embodiment will be described.

In the display device 1, the peripheral circuit section 20 performs ON/OFF control of a pixel circuit 13 of each pixel 11 as shown in FIGS. 1 and 2. Thus, a drive current is injected into an organic EL element 12R or the like of each pixel 11, and thus a hole and an electron are recombined, inducing light emission. The emitted light is multiply reflected between an anode and a cathode, and then extracted to the outside through the cathode and the like. As a result, an image based on the video signal 20a is displayed on the display section 10.

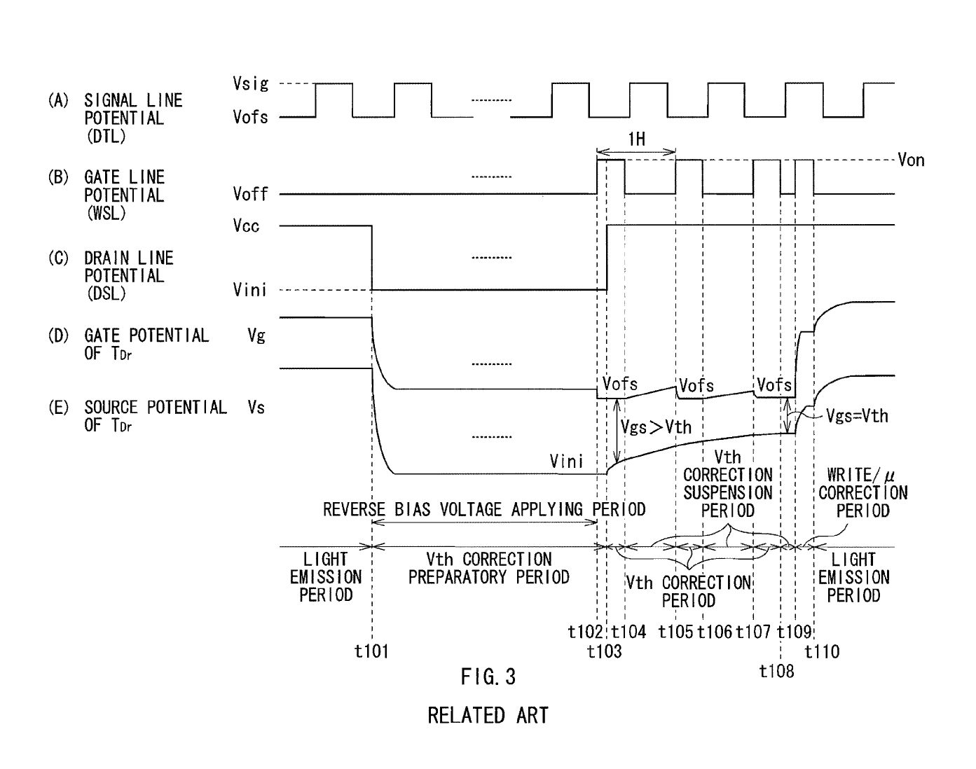

Here, operation of a display device in the past according to a comparative example will be described together with difficulties of the display device with reference to FIGS. 3 to 8.

FIG. 3 shows an example of various waveforms appearing in the display device according to the comparative example. FIG. 3 shows an aspect where the gate line WSL is applied with the two kinds of voltages (Vₒₙ and V_{off} (<Vₒₙ)), the drain line DSL is applied with the two kinds of voltages (V_{cc} and Vᵢₙᵢ (<V_{cc})), and the signal line DTL is applied with the two kinds of voltages (V_{sig} and V_{ofs} (<V_{sig})). Furthermore, FIG. 3 shows an aspect where gate voltage V_{g} and source voltage Vₛ of the transistor T_{Dr} change every moment in response to a voltage applied to each of the gate line WSL, the drain line DSL, and the signal line DTL.

Vₜₕ Correction Preparatory Period

First, preparation of Vₜₕ correction is performed in a period of timing t101 to timing t103 in the figure. Specifically, first, the power scan circuit 24 lowers the voltage of the drain line DSL from V_{cc} to Vᵢₙᵢ (timing t101). Thus, the source voltage Vₛ is lowered to Vᵢₙᵢ, and thus light emitted from the organic EL element 12R or the like is extinguished. At that time, the gate voltage V_{g} is also lowered due to coupling of the gate and the source via the retention volume Cₛ. Then, in a period where a voltage of the signal line DTL is V_{ofs}, the write scan circuit 23 raises a voltage of the gate line WSL from V_{off} to Vₒₙ (timing t102). Thus, the gate voltage V_{g} is lowered to V_{ofs}. The period of timing t101 to timing t102 corresponds to a period of applying reverse-bias voltage to the transistor T_{ws} as will be described later.

First Vₜₕ Correction Period

Next, Vₜₕ correction is performed in a period of timing t103 to timing t104 in the figure. Specifically, in a period where a voltage of the signal line DTL is V_{ofs}, the power scan circuit 24 raises the voltage of the drain line DSL from Vᵢₙᵢ to V_{cc} (timing t103). Thus, a current I_{ds} flows between the drain and the source of the transistor T_{Dr}, and thus the source voltage Vₛ is raised. Then, before the horizontal drive circuit 22 changes the voltage of the signal line DTL from V_{ofs} to V_{sig}, the write scan circuit 23 lowers the voltage of the gate line WSL from Vₒₙ to V_{off} (timing t104). Thus, the gate of the transistor T_{Dr} is turned into floating, so that the correction of Vₜₕ is temporarily stopped.

First Vₜₕ Correction Suspension Period

In a period where the first Vₜₕ correction is suspended (timing t104 to timing t105), sampling of a voltage of the signal line DTL is performed in a row (pixel) different from a row (pixel) subjected to the previous Vₜₕ correction. When the Vₜₕ correction is insufficient, the current I_{ds} flows between the drain and source of the transistor T_{Dr} in the row (pixel) subjected to the previous Vₜₕ correction even during the Vₜₕ correction suspension period. That is, when a voltage difference V_{gs} between the gate and source of the transistor T_{Dr} is larger than the threshold voltage Vₜₕ of the transistor T_{Dr}, the current I_{ds} flows between the drain and source of the transistor T_{Dr} in the row (pixel) subjected to the previous Vₜₕ correction even during the Vₜₕ correction suspension period. Thus, the source voltage V, is raised, and the gate voltage V_{g} is also raised due to coupling of the gate and the source via the retention volume Cₛ.

Second Vₜₕ Correction Suspension Period

After the first Vₜₕ correction suspension period is finished, Vₜₕ correction is performed again in a period of timing t105 to timing t106 in the figure. Specifically, when the voltage of the signal line DTL is V_{ofs}, and therefore Vₜₕ correction is enabled, the write scan circuit 23 raises the voltage of the gate line WSL from V_{off} to Vₒₙ (timing t105), so that the gate of the transistor T_{Dr} is connected to the signal line DTL. At that time, when the source voltage Vₛ is lower than (V_{ofs}−Vₜₕ) (when Vₜₕ correction is not completed yet), the current I_{ds} flows between the drain and source of the transistor T_{Dr} until the transistor T_{Dr} is cut off (until the voltage difference V_{gs} corresponds to Vₜₕ). As a result, the retention volume C, is charged to Vₜₕ, and the voltage difference V_{gs} becomes Vₜₕ. Then, before the horizontal drive circuit 22 changes the voltage of the signal line DTL from V_{ofs} to V_{sig}, the write scan circuit 23 lowers the voltage of the gate line WSL from Vₒₙ, to V_{off} (timing t106). Thus, since the gate of the transistor T_{Dr} is turned into floating, the voltage difference V_{g}, may be kept to Vₜₕ regardless of a voltage level. The voltage difference V_{g}, is set to Vₜₕ in this way, thereby even if the threshold voltage Vₜₕ of the transistor T_{Dr} varies for each pixel circuit 13, variation in emission luminance of the organic EL element 12R or the like may be eliminated.

Second Vₜₕ Correction Suspension Period

Then, Vₜₕ correction is suspended again in a period of timing t106 to timing t107 in the figure in the same way as the first Vₜₕ correction suspension period.

Third Vₜₕ Correction Period and Third Vₜₕ Correction Suspension Period

Then, third Vₜₕ correction is performed in a period of timing t107 to timing t108, and Vₜₕ correction is suspended in a period of timing t108 to timing t109 in the same way as the first and second Vₜₕ correction. The horizontal drive circuit 22 changes the voltage of the signal line DTL from V_{ofs} to V_{sig} during the third Vₜₕ correction suspension period.

Write/μ Correction Period

After the Vₜₕ correction suspension period is finished, write and μ correction are performed in a period of timing t109 to timing t110 in the figure. Specifically, in a period where the voltage of the signal line DTL is V_{sig}, the write scan circuit 23 raises the voltage of the gate line WSL from \T_{off} to Vₒₙ (timing t109), so that the gate of the transistor T_{Dr} is connected to the signal line DTL. Thus, gate voltage of the transistor T_{Dr} becomes V_{sig}. Anode voltage of the organic EL element 12R or the like is still lower than the threshold voltage Vₑₗ of the organic EL element 12R or the like, and therefore the organic EL element 12R or the like is cut off. Therefore, the current I_{ds} flows into element capacitance (not shown) of the organic EL element 12R or the like, so that the element capacitance is charged, and therefore the source voltage Vₛ is raised by ΔV, and eventually the voltage difference V_{gs} becomes (V_{sig}+Vₜₕ−ΔV). In this way, μ correction is performed concurrently with write. Since ΔV is increased with increase in mobility μ of the transistor T_{Dr}, the voltage difference V_{gs} is reduced by ΔV and then light emission is performed, variation in mobility μ for each pixel may be removed.

### Light Emission

Finally, the write scan circuit 23 lowers the voltage of the gate line WSL from Vₒₙ to V_{off} (timing t110). Thus, the gate of the transistor T_{Dr} is turned into floating, so that the current I_{ds} flows between the drain and source of the transistor T_{Dr}, and the source voltage Vₛ is raised. As a result, the organic EL element 12R or the like emits light with desired luminance.

Here, an operation state of the transistor T_{ws} is pointed in the above drive operation. The transistor T_{ws} is OFF in any period other than the Vₜₕ correction periods (timing t103 to timing t104, timing t105 to timing t106, and timing t107 to timing t108) and the write/μ correction period (timing t109 to timing t110).

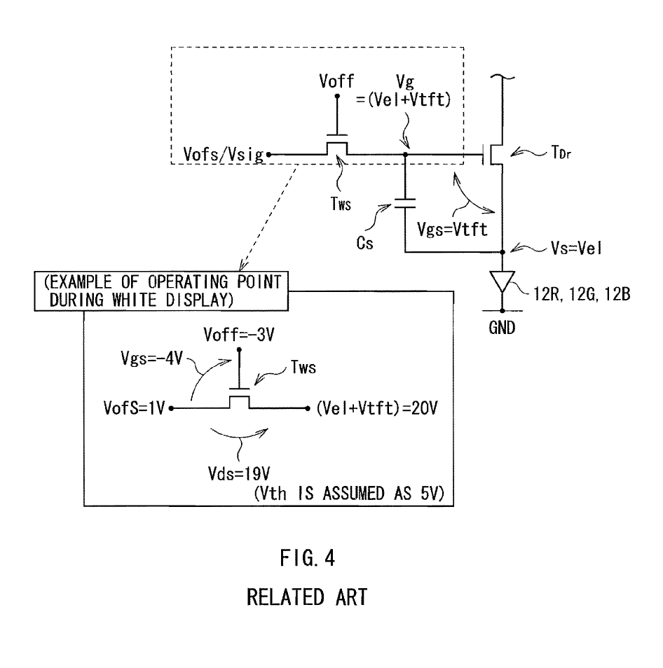

FIG. 4 shows an example of an operating point when the transistor T_{ws} is OFF (during white display). In the transistor T_{ws} during such white display, for example, V_{gs}=(V_{off}−V_{ofs})=−4V and V_{ds}=(Vₑₗ+V_{tft})−V_{ofs}=19V are given for the operating point, so that minus bias voltage (reverse bias voltage) is applied to the transistor T_{ws}. Here, a threshold voltage Vₜₕ of the transistor T_{ws} is assumed as 5V.

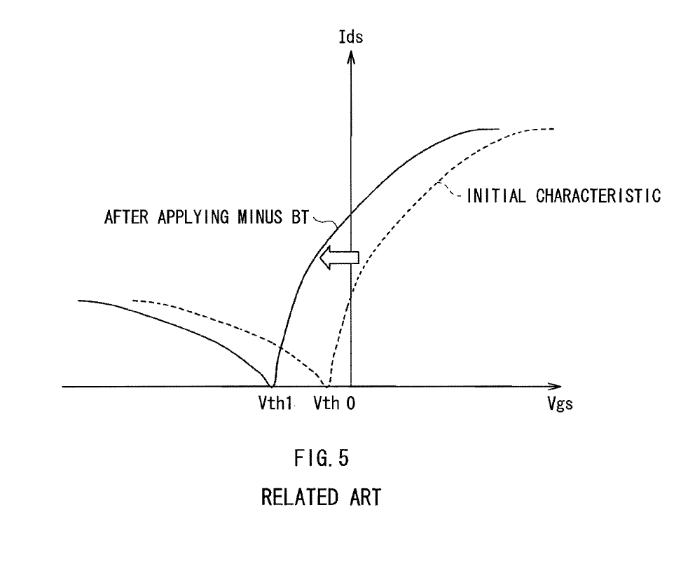

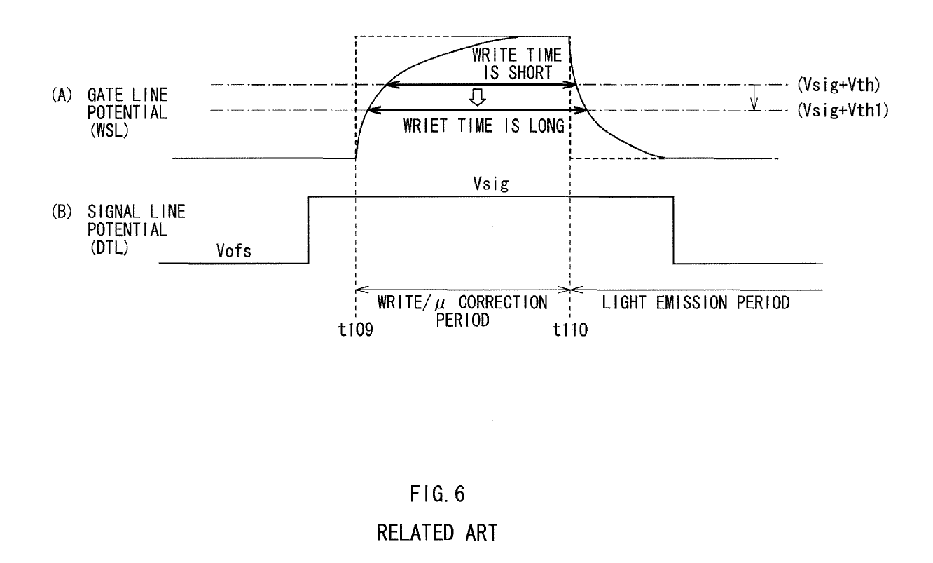

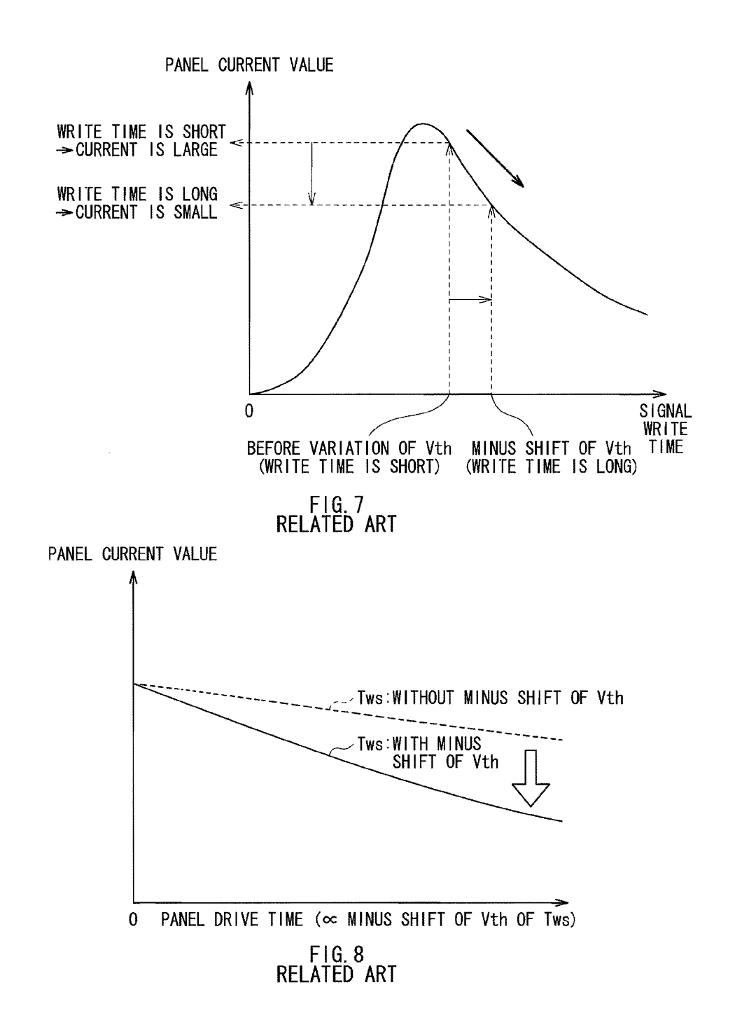

When such an operating point becomes dominant in the transistor T_{ws} (when minus bias is applied), the threshold voltage Vₜₕ of the transistor T_{ws} is temporally minus-shifted (varied in a negative voltage direction), for example, as shown in FIG. 5. When the threshold voltage Vₜₕ of the transistor T_{ws} is minus-shifted (the threshold voltage is assumed as Vₜₕ₁ in such a case), since the turn-on/cutoff point of the transistor T_{ws} is shifted to a lower voltage side, write time is lengthened, for example, as shown in FIG. 6. As a result, temporal reduction in light-emission current value (panel current value) is accelerated due to such lengthened write time, for example, as shown in FIGS. 7 and 8.

In this way, in the display device in the past according to the comparative example, temporal reduction in light-emission current value is accelerated due to the lengthened write time caused by variation in Vₜₕ of the transistor T_{ws}, causing reduction in reliability.

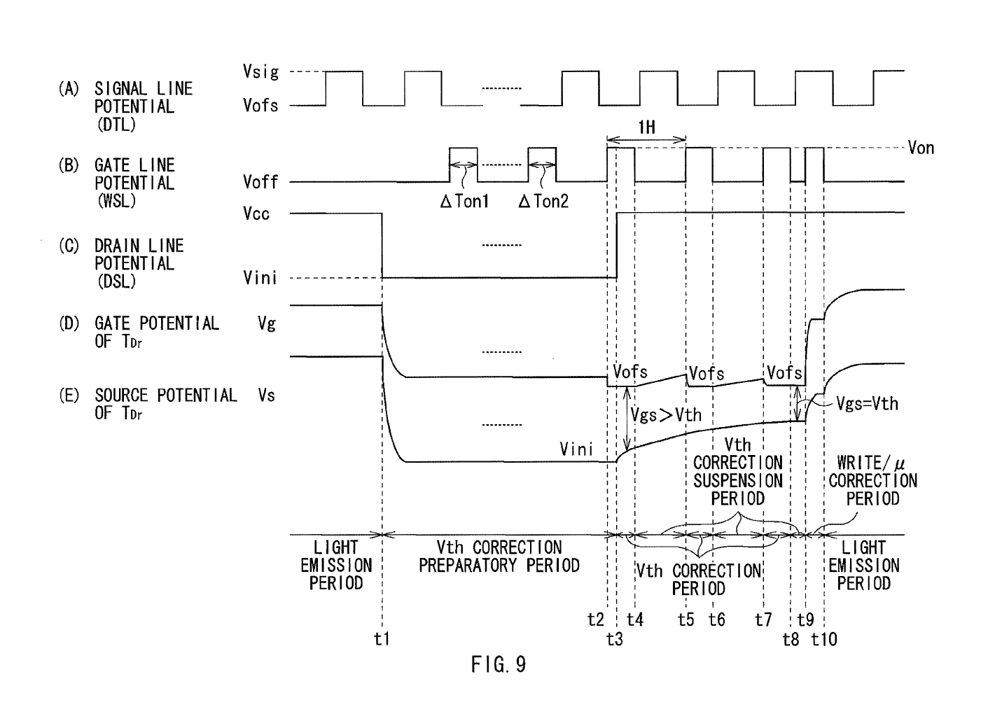

Thus, detailed operation of the display device 1 of the embodiment will be then described with reference to FIGS. 9 to 11.

FIG. 9 shows an example of various waveforms appearing in the display device 1. FIG. 9 shows an aspect where the gate line WSL is applied with two kinds of voltages (Vₒₙ and V_{off} (<Vₒₙ)), the drain line DSL is applied with two kinds of voltages (V_{cc} and Vᵢₙᵢ (<V_{cc})), and the signal line DTL is applied with two kinds of voltages (V_{sig} and V_{ofs} (<V_{sig})). Furthermore, FIG. 9 shows an aspect where gate voltage V_{g} and source voltage Vₛ of the transistor T_{Dr} vary every moment respectively. Timing t1 to timing t10 shown in FIG. 9 corresponds to timing t100 to timing t110 in the comparative example shown in FIG. 3.

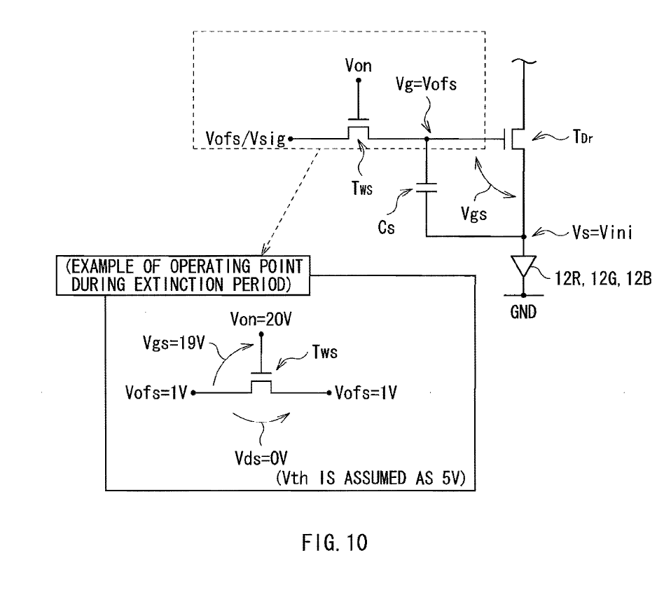

In the embodiment, as shown in FIG. 9, when voltage of the signal line DTL is V_{ofs} during an extinction period in which voltage of the drain line DSL is Vᵢₙᵢ (specifically, a Vₜₕ correction preparatory period of timing t1 to timing t3), the following operation is performed. That is, in such a case, voltage of the gate line WSL is raised from V_{off} to Vₒₙ, and then lowered from Vₒₙ to V_{off}, so that an ON period (for example, an ON period ΔTₒₙ₁ or ΔTₒₙ₂ in the figure) is provided. In this case, for example, V_{gs}=(Vₒₙ−V_{ofs})=19V and V_{ds}=V_{ofs}−V_{ofs}=0V are given for an operating point during the extinction period of the transistor T_{ws}, that is, plus bias voltage (forward bias voltage) is applied to the transistor, for example, as shown in FIG. 10.

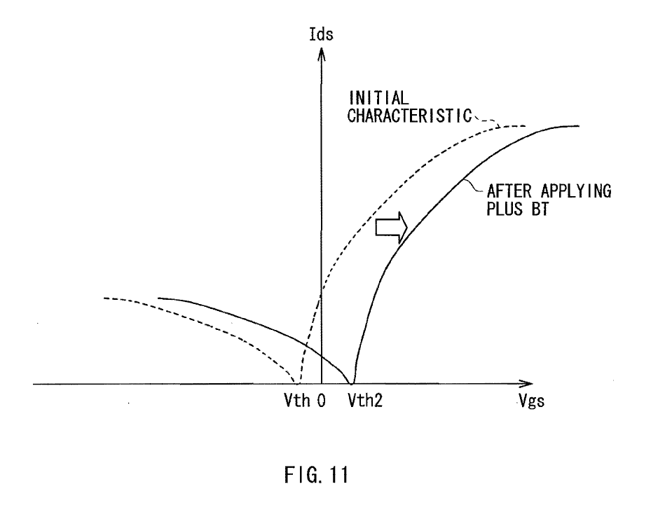

Thus, for example, as shown in FIG. 11, plus shift (variation in a positive voltage direction) of a threshold value Vₜₕ of a transistor T_{ws} is accelerated (threshold voltage after the variation is assumed as Vₜₕ₂). This resultantly enables cancelling a variation level of minus shift (variation in a negative voltage direction) of the threshold value Vₜₕ of the transistor T_{ws} in the past. Therefore, variation in Vₜₕ of the transistor T_{ws} is suppressed, leading to suppression of acceleration in temporal reduction in light emission current value (panel current value) due to lengthened write time caused by such variation in Vₜₕ.

As hereinbefore, in the embodiment, when the voltage of the signal line DTL is V_{ofs} during the extinction period in which the voltage of the drain line DSL is Vᵢₙᵢ, the voltage of the gate line WSL is raised from V_{off} to Vₒₙ, and then lowered from Vₒₙ to V_{off}, so that an ON period ΔTₒₙ₁ or ΔTₒₙ₂ is provided. Therefore, variation in Vₜₕ of the transistor T_{ws} is suppressed, and consequently acceleration in temporal reduction in light emission current value may be suppressed. Accordingly, reliability may be improved compared with the related art.

In addition, for example, when at least one of number of ON periods to be provided, such as ΔTₒₙ₁ and ΔTₒₙ₂ shown in FIG. 9, and length of each ON period is adjusted, the amount of plus shift of the threshold value Vₜₕ of the transistor T_{ws} may be adjusted. Accordingly, the amount of minus shift may be completely cancelled, and consequently reliability may be further improved.

### MODULE AND APPLICATION EXAMPLES

Hereinafter, description is made on application examples of the display device 1 described in the embodiment. The display device 1 of the embodiment may be applied to an electronic device in any filed, including a television device, a digital camera, a notebook personal computer, a mobile terminal device such as mobile phone, or a video camera. In other words, the display device 1 of the embodiment may be applied to a display device of an electronic device in any filed, the display device displaying an externally inputted video signal or an internally produced video signal in a form of a still or moving image.

Module

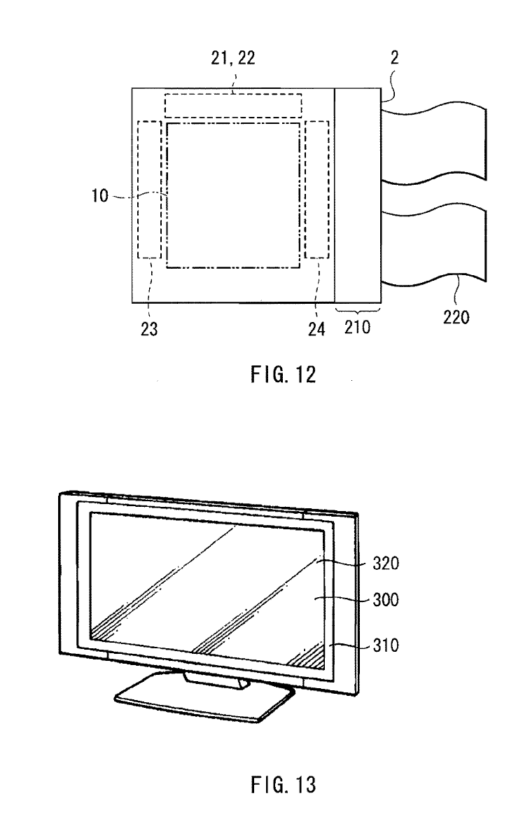

The display device 1 of the embodiment is incorporated in various electronic devices such as application examples 1 to 5 described later, for example, in a form of a module as shown in FIG. 12. The module has, for example, a region 210 exposed from a member (not shown) sealing the display section 10 on one side of the substrate 2. External connection terminals (not shown), which correspond to extensions of wirings of the timing control circuit 21, a horizontal drive circuit 22, a write scan circuit 23, and a power scan circuit 24 respectively, are formed on the exposed region 210. A flexible printed circuit (FPC) 220 for inputting or outputting a signal may be provided on the external connection terminals.

### Application Example 1

FIG. 13 shows appearance of a television device using the display device 1 of the embodiment. The television device has, for example, a video display screen section 300 including a front panel 310 and a filter glass 320, and the section 300 includes the display device 1 according to the embodiment.

### Application Example 2

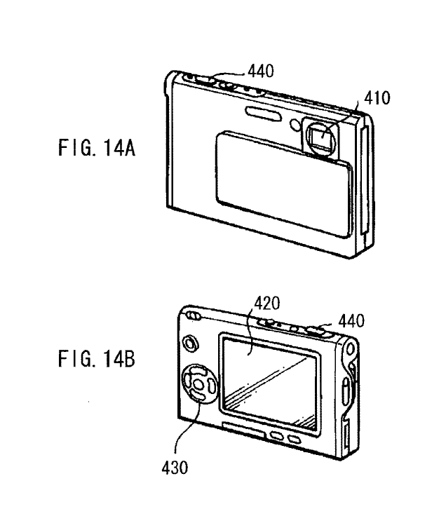

FIGS. 14A and 14B show appearance of a digital camera using the display device 1 of the embodiment. The digital camera has, for example, a flash light emission section 410, a display section 420, a menu switch 430, and a shutter button 440, and the display section 420 includes the display device 1 according to the embodiment.

### Application Example 3

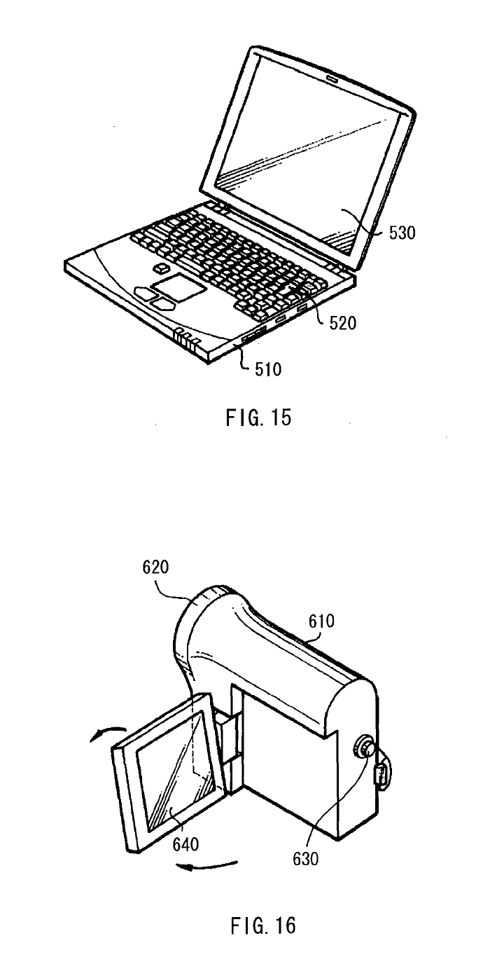

FIG. 15 shows appearance of a notebook personal computer using the display device 1 of the embodiment. The notebook personal computer has, for example, a body 510, a keyboard 520 for input operation of letters and the like, and a display section 530 for displaying an image, and the display section 530 includes the display device 1 according to the embodiment.

### Application Example 4

FIG. 16 shows appearance of a video camera using the display device 1 of the embodiment. The video camera has, for example, a body section 610, an object-photographing lens 620 provided in a front side face of the body section 610, a photographing start/stop switch 630, and a display section 640, and the display section 640 includes the display device 1 according to the embodiment.

### Application Example 5

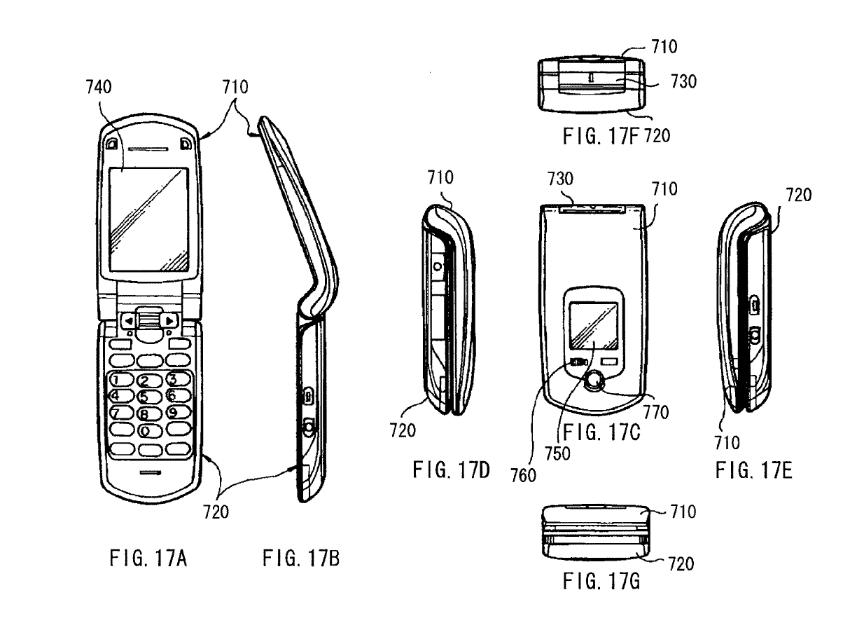

FIGS. 17A to 17G are views showing appearance of a mobile phone using the display device 1 of the embodiment. The mobile phone includes, for example, an upper housing 710 and a lower housing 720, the housings being connected by a connection section (hinge) 730, and has a display 740, a sub-display 750, a picture light 760, and a camera 770. The display 740 or the sub-display 750 includes the display device 1 according to the embodiment.

While the invention has been described with the embodiments and the application examples hereinbefore, the invention is not limited to the embodiments and the like, and may be variously modified or altered.

For example, while the embodiments and the like are described with a case where the display device 1 is an active matrix device, a configuration of the pixel circuit 13 for active matrix drive is not limited to that described in the embodiments and the like. For example, a capacitance element or a transistor may be added to the pixel circuit 13 according to demand. In such a case, a necessary drive circuit may be added in addition to the horizontal drive circuit 22, the write scan circuit 23, and the power scan circuit 24 depending on alteration in pixel circuit 13.

While the display-signal hold control circuit 21B controls drive of each of the horizontal drive circuit 22, the write scan circuit 23, and the power scan circuit 24 in the embodiments and the like, another circuit may control the drive of each circuit. Moreover, control of the horizontal drive circuit 22, write scan circuit 23, or power scan circuit 24 may be performed by hardware (a circuit) or by software (a program).

Furthermore, while the embodiments and the like are described with the organic EL element 12R or the like as an example of a photo-emission element, the invention may be applied to another photo-emission element such as LED (Light Emitting Diode).

It should be understood by those skilled in the art that various modifications, combinations, sub-combinations and alterations may occur depending on design requirements and other factors insofar as they are within the scope of the appended claims or the equivalent thereof.

1. (canceled)

2. (canceled)

3. (canceled)

4. (canceled)

5. (canceled)

6. (canceled)

7. A display device, comprising for each pixel:
a photo-emission element and a first MOS transistor connected in series between a first power source line and a second power source line;
a capacitor connected to be inserted between a gate and a source of the first MOS transistor; and
a second MOS transistor connected to be inserted between a signal line to be applied with a image signal voltage and the gate of the first MOS transistor, the second MOS transistor being controlled by a scan signal to change between ON-state and OFF-state,
wherein
ON-period of the first transistor is established within a period in which the photo-emission element is maintained to an extinction state and the signal line is applied with a voltage having a fixed level independent from the image signal voltage.
